(19) United States
(12) Patent Application Publication
(10) Pub. No.: US 2019/0119607 A1
(43) Pub. Date: Apr. 25, 2019

(54) LAUNDRY LIQUID COMPOSITION

(71) Applicant: Conopco, Inc., d/b/a UNILEVER, Englewood Cliffs, NJ (US)

(72) Inventors: Andrew David Green, Merseyside (GB); Alyn James Parry, Merseyside (GB)

(21) Appl. No.: 16/091,879

(22) PCT Filed: Feb. 23, 2017
(86) PCT No.: PCT/EP2017/054206

§ 371 Date: Oct. 5, 2018

(30) Foreign Application Priority Data
Apr. 8, 2016 (EP) 16164417.4

(51) Int. Cl. C11D 3/37; C11D 1/22; C11D 1/29; C11D 17/00; C11D 3/48; C11D 11/00

(52) U.S. Cl. CPC C11D 3/3715; C11D 1/22; C11D 11/0017; C11D 17/0008; C11D 3/48; C11D 1/29

(57) ABSTRACT

A laundry liquid composition, comprising an anionic soil release polymer and a surfactant wherein the anionic soil release polymer comprises a fabric-binding region capped by one or more hydrophilic regions, wherein the fabric-binding region includes one or more anionic substituents and at least one end block/cap based on polyethylene glycol and/or polypropylene glycol, with a lower alkyl or hydrogen termination, and wherein the anionic soil release polymer may be a compound having formula (I) or, more preferably, formula (^{II}) where each Y is independently selected from y^{A1}, Y^{A2}, Y^{N1} and Y^{N2}wherein: y^{A1} is a 1,4-phenylene moiety having one or more (e.g. 1, 2, 3 or 4) anionic substituents (such as carboxylate, phosphonate, phosphate or, preferably sulphonate); Y^{A2} is a 1,3-phenylene moiety having one or more (e.g. 1, 2, 3 or 4) anionic substituents (such as carboxylate, phosphonate, phosphate or, preferably sulphonate); Y^{N1} is an anionic-substituent free (e.g. unsubstituted) 1,4-phenylene moiety; and Y^{N2} is an anionic-substituent free (e.g. unsubstituted) 1,3-phenylene moiety; E is an end-cap, A is C₁₋₆alkyl (preferably ethylene substituted with C₁-4 alkyl substituents); M′ is a suitable counterion; and x>0; with the proviso that at least one Y group is y^{A1} or Y^{A2} and wherein the end cap E comprises polyethylene glycol and/or polypropylene glycol units, with a C1-C6 alkyl or hydrogen termination.

E-[OC(O)—Y—C(O)O-A]ₓ-OC(O)—Y—C(O)OM′ (I)

E-[OC(O)—Y—C(O)O-A]ₓ-OC(O)—Y—C(O-E (II)

### TECHNICAL FIELD

The present invention relates to laundry liquid compositions incorporating soil release polymers (“SRPs”).

### BACKGROUND

Laundry detergent compositions containing polyester soil release polymers have been widely disclosed in the art.

DE 10 2007 013 217 A1 and WO 2007/079850 A1 disclose anionic polyesters that may be used as soil release components in washing and cleaning compositions.

DE 10 2007 005 532 A1 describes aqueous formulations of soil release oligo- and polyesters with a low viscosity. The aqueous formulations may for example be used in washing and cleaning compositions.

EP 0 964 015 A1 discloses soil release oligoesters that may be used as soil release polymers in detergents and that are prepared using polyols comprising 3 to 6 hydroxyl groups.

EP 1 661 933 A1 is directed to room temperature flowable, amphiphilic and nonionic oligoesters prepared by reacting dicarboxylic acid/ester compounds, polyol compounds and water-soluble alkylene oxide adducts and their use as additive in washing and cleaning compositions.

WO 2014/019903 describe polymers with improved hydrolytic stability.

US 2013/0200290 discloses aqueous concentrates containing 12 to 60 wt. % anionic soil release polymers which are said to have good greying inhibition performance and minimal tendency to crystallise in aqueous solution. The improved properties are said to result from incorporating specific ratios of propylene glycol and ethylene glycol units in the polymer. The concentrates may be used in washing and cleaning compositions.

Despite their advantages, formulating soil release polymers in detergent liquids is often difficult in terms of formulation compatibility, polymer solubility and stability with careful polymer design required to achieve this. There is a trend to utilise non-ionic polyester soil release polymers in liquid detergents because of their better compatibility and solubility.

Users of liquid detergent products expect those products to have acceptable sensorial properties, such as appearance, colour, fragrance and viscosity. Unfortunately, inclusion of soil release polymer in typical detergent compositions leads to a catastrophic reduction in product viscosity, particularly those incorporating anionic surfactants, with the result that costly thickening technology is required to restore viscosity. Inclusion of thickeners is undesirable since, as well as being costly, they often have no beneficial effects in terms of cleaning and indeed in many cases can lead to cleaning negatives.

What is required is a soil release polymer that confers good performance without reducing product viscosity. This would increase the range of compositions in which the polymers can be included, and provide consumers with greater choice.

### SUMMARY OF THE INVENTION

The inventors have discovered that the fabric-binding region of the non-ionic SRPs commonly used in liquid detergent compositions have a propensity to interact with surfactants. It is believed that this interaction disrupts the formation of worm-like surfactant micelles, leading to a loss of viscosity.

However, the present inventors have found that certain negatively-charged SRPs (“soil release polymers”) display minimal or no interaction with surfactant, allowing them to be formulated into surfactant-containing liquid compositions with no or minimal loss of viscosity.

Accordingly, in a first aspect, the present invention provides a laundry liquid composition according to claim 1.

The laundry liquid composition is suitable for cleaning fabrics, most preferably polyester or polyester-blend fabrics. In such instances, the anionic soil release polymer is a “polyester anionic soil release polymer”. Suitably, the laundry liquid composition is a laundry liquid detergent composition.

Suitably, the anionic soil release polymer and surfactant are provided as a mixture. Advantageously, this allows soil release and cleaning components to be added to a wash liquor as part of the same composition, instead of having to add the components separately. These mixtures may be suitable for long-term storage, due to the minimal or lack of interaction between the components.

By “anionic soil release polymer” we mean a soil release polymer which is capable of developing a negative charge when present in the laundry liquid composition. The net negative charge may be provided by anionic substituents, such as those incorporating acid-derived substituent groups (e.g. sulphonate groups).

The soil release polymer has one or more fabric-binding regions, to provide fabric substantivity. For example, the soil release polymer may include a fabric-binding region capped by one or more hydrophilic regions. Typically, the fabric-binding region forms the central portion of the molecule (the “midblock”) and is capped by hydrophilic groups. The anionic substituents are provided on the fabric-binding region and/or on the end cap, since these disrupt surfactant interaction with the soil release polymer.

Preferably, the fabric-binding region is a polyester polymer or copolymer region.

One preferred class of anionic soil release polymers comprise fabric-binding regions incorporating a proportion of substituted dicarboxylic acid/ester monomer units.

For example, the anionic soil release polymer may comprise a fabric-binding region formed from aromatic dicarboxylic acid/ester monomer units. Most preferably, the anionic soil release polymer is formed from aromatic dicarboxylic acid/ester and alkylene glycol units (including polymers containing polyalkylene glycols), such as those described in US 2013/0200290. Examples of suitable polymers include Texcare® SRA 100N or Texcare® SRA 300F marketed by Clariant®.

The midblock of the anionic soil release polymer may also comprise unsubstituted isophthalate and/or terephthalate units.

The proportion of Y groups bearing an anionic substituent (i.e. groups Y^{A1} and Y^{A2}) may be less than 50%, less than 40%, less than 30%, less than 25%, less than 20%, less than 15%, less than 10%, less than 5% or less than 3% of all Y groups.

Each Y is independently selected from Y^{A1}, Y^{A2}, Y^{N1} and Y^{N2} wherein:
Y^{A1} is a 1,4-phenylene moiety having one or more (preferably 1, 2, 3 or 4) anionic substituents (such as carboxylate, phosphonate, phosphate or, preferably sulphonate);
Y^{A2} is a 1,3-phenylene moiety having one or more (preferably 1, 2, 3 or 4) anionic substituents (such as carboxylate, phosphonate, phosphate or, preferably sulphonate);
Y^{N1} is 1,4-phenylene moiety and preferably free from anionic substitution anionic-substituent; and

Y^{N2} iₛ 1,3-phenylene moiety and preferably free from anionic-substituent;

Preferably, each Y is independently selected from Y^{A1}, Y^{N1}, and Y^{N2}.

Preferably, each Y is independently selected from Y^{A2}, Y^{N1}, and Y^{N2}.

Preferably, each Y is independently selected from Y^{A1} and Y^{N1}.

Preferably, A is a C1-6 alkyl ethylene substituted with C1-C4 alkyl substituents.

M′ is H or a counterion such as ammonium or a metal ion such as an alkali metal ion.

The anionic soil release polymer may be present at, for example, at least 0.001 wt. %, at least 0.005 wt. %, at least 0.01 wt. %, at least 0.5 wt. %, at least 0.1 wt. % or at least 0.5 wt. % of the liquid laundry composition. The upper limit for the amount of anionic soil release polymer may be, for example, 25 wt. %, 20 wt. %, 15 wt. %, 10 wt. %, 5 wt. %, 3 wt. %, 2 wt. %, 1.5 wt. %, 1 wt. % or 0.5 wt. % of the liquid laundry composition.

The total amount of soil release polymers in the composition may be, for example, less than 25 wt. %, less than 20 wt. %, less than 15 wt. %, less than 10 wt. %, less than 5 wt. %, less than 3 wt. %, less than 2 wt. %, less than 1.5 wt. %, less than 1 wt. % or less than 0.5 wt. % of the liquid laundry composition.

A preferred range for the amount of anionic soil release polymer may be, for example, 0.1 to 5 wt. % or 0.1 to 3 wt. %. Advantageously, compositions containing this amount of the anionic soil release polymer may be storage-stable and provide suitable anti-deposition characteristics, without adversely thinning the compositions. Such compositions may produce good soil release characteristics in a cost-effective manner, using relatively small amounts of SRP and small amounts of thickening agents.

The weight average molecular weight of the anionic polymeric soil release agent may be at least 1,000, at least 2,000, at least 5,000, at least 10,000, at least 15,000, at least 20,000 or at least 25,000. The upper limit for the weight average molecular weight may be, for example, 100,000; 75,000; 60,000; 55,000; 50,000; 40,000 or 30,000. For example, the weight average molecular weight may be between about 5,000 to about 50,000, such as between about 1,200 to 12,000.

Suitable anionic soil release polymers can be synthesised by conventional techniques well-known the skilled person, such as those described in US 2013/0200290.

### Surfactant

The laundry liquid compositions comprise one or more surfactants, which assist in removing soil from the textile materials and also assist in maintaining removed soil in solution or suspension in the wash liquor.

The surfactant may be selected from anionic, cationic, non-ionic and zwitterionic surfactants, and mixtures thereof.

Preferably, the surfactant comprises an anionic surfactant. Most preferably, the surfactant is (i.e. consists of) an anionic surfactant, or a blend of anionic and nonionic surfactants. The present inventors have found that compositions comprising an anionic surfactant and an anionic soil release polymer have particularly good viscosity and soil removal characteristics.

The amount of anionic surfactant is preferably at least 5 wt %.

### Anionic

Preferred alkyl sulphonates are alkylbenzene sulphonates, particularly linear alkylbenzene sulphonates having an alkyl chain length of C₈-C₁₅. The counter ion for anionic surfactants is generally an alkali metal, typically sodium, although other counter-ions for example MEA, TEA or ammonium can be used.

Suitable linear alkyl benzene sulphonate surfactants include Detal LAS with an alkyl chain length of from 8 to 15, more preferably 12 to 14.

It is further desirable that the composition comprises an alkyl polyethoxylate sulphate anionic surfactant of the formula (I):

RO(C₂H₄O)ₓSO₃⁻M⁺ (I)

where R is an alkyl chain having from 10 to 22 carbon atoms, saturated or unsaturated, M is a cation which makes the compound water-soluble, especially an alkali metal, ammonium or substituted ammonium cation, and x averages from 1 to 15.

Preferably R is an alkyl chain having from 12 to 16 carbon atoms, M is sodium and x averages from 1 to 3, preferably x is 3; This is the anionic surfactant sodium lauryl ether sulphate (SLES). It is the sodium salt of lauryl ether sulphonic acid in which the predominantly C12 lauryl alkyl group has been ethoxylated with an average of 3 moles of ethylene oxide per mole.

### Nonionic

Nonionic surfactants include primary and secondary alcohol ethoxylates, especially C₈-C₂₀ aliphatic alcohol ethoxylated with an average of from 1 to 20 moles of ethylene oxide per mole of alcohol, and more especially the C₁₀-C₁₅ primary and secondary aliphatic alcohols ethoxylated with an average of from 1 to 10 moles of ethylene oxide per mole of alcohol. Non-ethoxylated nonionic surfactants include alkyl polyglycosides, glycerol monoethers and polyhydroxy amides (glucamide). Mixtures of nonionic surfactant may be used. When included therein the composition suitably contains from 0.2 wt % to 40 wt %, preferably 1 wt % to 25 wt %, more preferably 5 to 20 wt % or 15 wt % of a non-ionic surfactant, for example alcohol ethoxylate, nonylphenol ethoxylate, alkylpolyglycoside, alkyldimethylamineoxide, ethoxylated fatty acid monoethanolamide, fatty acid monoethanolamide, polyhydroxy alkyl fatty acid amide, or N-acyl N-alkyl derivatives of glucosamine (“glucamides”).

Nonionic surfactants that may preferably be used include the primary and secondary alcohol ethoxylates, especially the C₈-C₂₀ aliphatic alcohols ethoxylated with an average of from 1 to 35 moles of ethylene oxide per mole of alcohol, and more especially the C₁₀-C₁₅ primary and secondary aliphatic alcohols ethoxylated with an average of from 1 to 10 moles of ethylene oxide per mole of alcohol.

### Amine Oxide

The composition may comprise up to 10 wt % of an amine oxide of the formula:

R¹N(O)(CH₂R²)₂

In which R¹ is a long chain moiety each CH₂R² are short chain moieties. R² is preferably selected from hydrogen, methyl and —CH₂OH. In general R¹ is a primary or branched hydrocarbyl moiety which can be saturated or unsaturated, preferably, R¹ is a primary alkyl moiety. R¹ is a hydrocarbyl moiety having chain length of from about 8 to about 18.

Preferred amine oxides have R¹ is C₈-C₁₈ alkyl, and R² is H. These amine oxides are illustrated by C₁₂₋₁₄ alkyldimethyl amine oxide, hexadecyl dimethylamine oxide, octadecylamine oxide.

A preferred amine oxide material is Lauryl dimethylamine oxide, also known as dodecyldimethylamine oxide or DDAO. Such an amine oxide material is commercially available from Huntsman under the trade name Empigen® OB.

Amine oxides suitable for use herein are also available from Akzo Chemie and Ethyl Corp.

Whereas in certain of the preferred embodiments R² is H, it is possible to have R² slightly larger than H. Specifically, R² may be CH₂OH, for example: hexadecylbis(2-hydroxyethyl)amine oxide, tallowbis(2-hydroxyethyl)amine oxide, stearylbis(2-hydroxyethyl)amine oxide and oleylbis(2- hydroxyethyl)amine oxide.

Preferred amine oxides have the formula:

O⁻—N⁺(Me)₂R¹ (3)

where R¹ is C₁₂₋₁₆ alkyl, preferably C₁₂₋₁₄ alkyl; Me is a methyl group.

### Zwitterionic

Nonionic-free systems with up to 95% wt LAS can be made provided that some zwitterionic surfactant, for example carbobetaine, is present. A preferred zwitterionic material is a carbobetaine available from Huntsman under the name Empigen® BB. Betaines and/or amine oxides, improve particulate soil detergency in the compositions. Another preferred betaine is cocoamidopropylbetaine (CAPB).

### Polyalkylene Imines and Derivatives Thereof

The liquid laundry composition may also comprise a polyalkylene imine, preferably modified polyalkylene imine, preferably a modified polyethylene imine.

Polyalkylene imine materials can cause a reduction in viscosity when added to liquid laundry compositions, especially in compositions containing high levels of anionic surfactants. The anionic soil release polymer may reduce or prevent the loss of viscosity produced by polyalkylene imines. Thus compositions of the anionic soil release polymer, surfactant and polyalkylene imine may be produced with minimal levels of thickening agents, helping to reduce costs.

Polyethylene imines are materials composed of ethylene imine units —CH2CH2NH— and, where branched, the hydrogen on the nitrogen is replaced by another chain of ethylene imine units. These polyethyleneimines can be prepared, for example, by polymerizing ethyleneimine in the presence of a catalyst for example carbon dioxide, sodium bisulphite, sulphuric acid, hydrogen peroxide, hydrochloric acid, acetic acid, and the like.

Specific methods for preparing these polyamine backbones are disclosed in U.S. Pat. No. 2,182,306, Ulrich et al., issued Dec. 5, 1939; U.S. Pat. No. 3,033,746, Mayle et al., issued May 8, 1962; U.S. Pat. No. 2,208,095, Esselmann et al., issued Jul. 16, 1940; U.S. Pat. No. 2,806,839, Crowther, issued Sep. 17, 1957; and U.S. Pat. No. 2,553,696, Wilson, issued May 21, 1951.

Preferably, the EPEI comprises a polyethyleneimine backbone of about 300 to about 10000 weight average molecular weight; wherein the modification of the polyethyleneimine backbone is intended to leave the polymer without quaternisation. Such nonionic EPEI may be represented as PEI(X)YEO where X represents the molecular weight of the unmodified PEI and Y represents the average moles of ethoxylation per nitrogen atom in the polyethyleneimine backbone. The ethoxylation may range from 5 to 40 ethoxy moieties per modification.

The polyethyleneimine polymer is present in the composition preferably at a level of between 0.01 and 25 wt %, but more preferably at a level of at least 2 wt % and/or less than 9.5 wt %, most preferably from 3 to 9 wt %.

A ratio of non-soap surfactant to EPEI could optionally be from 2:1 to 15:1, conveniently from 2:1 to 12:1 or 7:1, preferably from 3:1 to 6:1, or even to 5:1.

### Other Components

As noted above, the anionic soil release polymer does not produce the drop in viscosity observed for non-ionic SRPs, reducing or obviating the need for thickening agents. This is useful, because thickening agents can increase the costs of the formulations without providing any cleaning benefits.

Accordingly, the present invention includes compositions which contain relatively low levels of thickening polymers. For example, the compositions may contain less than 5 wt. % thickening polymer, less than 3 wt. % thickening polymer, less than 2 wt. %

thickening polymer, less than 1 wt. % thickening polymer; less than 0.5 wt. % thickening polymer; less than 0.25 wt. % thickening polymer; less than 0.1 wt. % thickening polymer; less than 0.05 wt. % thickening polymer; less than 0.01 wt. % thickening polymer, or 0% thickening polymer. The compositions may be free or substantially free of thickening polymers.

By “thickening polymer”, we mean a polymer which is added to the composition to increase the viscosity of the laundry liquid detergent, without substantially changing the liquid's other properties. Examples of thickening polymers include, for example, polyacrylates (including water swellable and alkali swellable polyacrylates) such as ASE polymers and HASE polymers; and hydrophobically-modified ethoxylated urethane polymers (HEUR).

The laundry liquid composition may comprise other optional additives, such as builders, sequestrants, bleaches, perfume, foam boosting agents, preservatives (e.g. bactericides), pH buffering agents, polyelectrolytes, anti-shrinking agents, anti-wrinkle agents, anti-oxidants, sunscreens, anti-corrosion agents, drape imparting agents, anti-static agents, ironing aids, colorants, pearlisers and/or opacifiers, shading dye, fluorescent agents, dye transfer inhibition polymers, and anti redeposition polymers and/or soil release polymers, especially those based on modified polyesters, polyelectrolytes and cellulosic materials.

The laundry liquid composition may also comprise one or more enzymes. The enzymes may be selected from lipase, phospholipase, protease, cutinase, amylase, cellulase, (per)oxidase, pectate lyase, mannanase and mixtures thereof.

The laundry liquid composition may be an aqueous composition consisting of:

(i) water;

(ii) an anionic soil release polymer (preferably in the amounts specified above);

(iii) an anionic surfactant;
and optionally

(iv) modified polyalkyleneimine;

(v) one or more enzymes; and/or

(vi) one or more optional additives selected from builders, sequestrants, bleaches, perfume, foam boosting agents, preservatives (e.g. bactericides), pH buffering agents, polyelectrolytes, anti-shrinking agents, anti-wrinkle agents, anti-oxidants, sunscreens, anti-corrosion agents, drape imparting agents, anti-static agents, ironing aids, colorants, pearlisers and/or opacifiers, shading dye, fluorescent agents, dye transfer inhibition polymers, anti redeposition polymers and soil release polymers.

In such instances, the composition may contain only low levels of thickening polymers. (i.e. polymers which are added to increase the viscosity of the laundry liquid detergent without substantially changing the liquid's other properties).

### pH

The pH of the composition is chosen to provide suitable laundry cleaning, whilst maintaining the overall negative charge of the soil release polymer. The pH may be at least 3, at least 4, or at least 5. The upper limit for the pH may be, for example, 10; 9; or 8. For example, the pH may be in the range of about 3 to about 8.

### Viscosity

The composition may have a viscosity at 25° C. of, for example, more than 5 mPa·s; more than 10 mPa·s; more than 25 mPa·s; more than 50 mPa·s; more than 100 mPa·s; more than 200 mPa·s; more than 300 mPa·s; or more than 400 mPa·s.

The viscosity may be measured at a shear rate of 23 s⁻¹. For example, the viscosity may be measured using a Paar Physica MCR300 machine operating in geometry CC27 (profiled DIN concentric cylinder) at a shear rate of 23 s⁻¹ and temperature of 25° C.

As noted above, the anionic soil release polymer used in the present invention can be used without the need for substantial amounts of thickening polymers.

Thus the present invention provides a laundry liquid composition comprising an anionic soil release polymer and surfactant, wherein the composition has a viscosity at 25° C. of greater than 400 mPa·s.

### Product Forms

As noted above, the laundry liquid compositions of the present invention are relatively stable, due to the lack of, or minimal, interaction between the anionic soil release polymer and surfactant. Thus, advantageously, the compositions of the present invention are sufficiently stable to be stored before use.

Therefore, in a further aspect, the present invention provides a package containing a composition according to the first aspect. The anionic soil release polymer and surfactant are provided as an admixture in such packages. The package may be any form of suitable container, for example, a bottle or sachet.

### Uses

In a further aspect, the present invention provides a method of cleaning a fabric using a composition of the first aspect. The fabric may be a polyester or polyester-blend fabric.

### EXAMPLES

Experiments were carried out to demonstrate the improved viscosity characteristics of compositions incorporating anionic SRPs.

### Example 1

An anionic polyester soil release polymer (Texcare® SRA-100N, Clariant) was dissolved in a liquid detergent base, to produce a composition according to Table 1:

TABLE 1
Liquid detergent compositions

| | w/w % as 100% active |
|---|---|
| NaCl | 1.88 |
| NaOH | 0.218 |
| Triethanolamine | 0.667 |
| Citric acid | 0.178 |
| LAS acid | 2.0 |
| Soil release polymer | 0.5 |
| SLES 3EO | 6.0 |
| Cocamidopropyl betaine | 1.5 |
| plus antifoam, fluorescer, | to 100% |
| fragrance, preservatives | |
| and demineralised water | |

### Comparative Example 1

A sample was produced having an identical composition to that shown in Table 1 but with a non-ionic polyester SRP as described in WO 2014/019903 used in place of the anionic polyester SRP.

### Results

The viscosity of the compositions of Example 1 and Comparative Example 1 were measured at a temperature of 25° C. and shear rate of 23 s⁻¹ using a Physica MCR300 rheometer (Anton Paar) operating with a cylinder geometry (geometry CC27—profiled DIN concentric cylinder). The measurement was carried out using a three step process: (i) controlled stress steps from 0.01 to 400 Pa, terminating once a shear rate of 0.1 s⁻¹ is reached; (ii) controlled shear rate steps from 0.1 to 1200 s⁻¹ and (iii) controlled shear rate steps from 1200 to 0.1 s⁻¹. The results shown in Table 2 show that the non-ionic SRP produced a significant thinning effect on the composition, and that the anionic SRP had a significantly higher viscosity.

TABLE 2

| | Viscosity (mPa · s) |
|---|---|
| Example 1 | 1600 |
| Comparative Example 1 | 159 |

1. A laundry liquid composition, comprising an anionic soil release polymer and a surfactant wherein the anionic soil release polymer comprises a fabric-binding region capped by one or more hydrophilic regions, wherein the fabric-binding region includes one or more anionic substituents and at least one end block/cap based on at least one of polyethylene glycol or polypropylene glycol, with a lower alkyl or hydrogen termination, and wherein the anionic soil release polymer is one of: a compound having formula (I) or a compound having formula (II):
E-[C(O)—Y—C(O)O-A]ₓ-OC(O)—Y—C(O)OM′ (I)
E-[C(O)—Y—C(O)O-A]ₓ-OC(O)—Y—C(O)O-E (II)
where each Y is independently selected from Y^{A1}, Y^{A2}, Y^{N1} and Y^{N2} wherein:
Y^{A1} is a 1,4-phenylene moiety having one or more anionic substituents;
Y^{A2} is a 1,3-phenylene moiety having one or more anionic substituents;
Y^{N1} is an anionic-substituent free 1,4-phenylene moiety; and
Y^{N2} is an anionic-substituent free 1,3-phenylene moiety;
A is C₁₋₆ alkyl; M′ is a suitable counterion; and x>0; with the proviso that at least one Y group is Y^{A1} or Y^{A2} and wherein E is an end-cap comprising at least one of polyethylene glycol or polypropylene glycol units, with a C1-C6 alkyl, hydrogen or sulphate termination.

2. The laundry liquid composition according to claim 1, wherein the surfactant comprises an anionic surfactant.

3. The laundry liquid detergent composition according to claim 1, wherein the anionic soil release polymer comprises 0.1 to 5 wt. % of the composition.

4. The laundry liquid detergent composition according to claim 3, wherein the anionic soil release polymer comprises 0.1 to 3 wt. % of the composition.

5. The laundry liquid detergent composition according to claim 1, wherein the composition consists of:
(i) water;
(ii) the anionic soil release polymer;
(iii) the surfactant, wherein the surfactant is an anionic surfactant;
and optionally at least one of:
(iv) modified polyalkyleneimine
(v) one or more enzymes; or
(vi) one or more additives selected from the group consisting of builders, sequestrants, bleaches, perfume, foam boosting agents, preservatives, pH buffering agents, polyelectrolytes, anti-shrinking agents, anti-wrinkle agents, anti-oxidants, sunscreens, anti-corrosion agents, drape imparting agents, anti-static agents, ironing aids, colorants, pearlisers, opacifiers, shading dye, fluorescent agents, dye transfer inhibition polymers, anti redeposition polymers, soil release polymers, and combinations thereof.

6. A laundry liquid composition according to claim 1, wherein the composition has a viscosity at 25° C. of greater than 200 mPa·s.

7. A package containing the laundry liquid composition according to claim 1.

8. The laundry liquid composition of claim 1, wherein
Y^{A1} is a 1,4-phenylene moiety having 1 to 4 anionic substituents.

9. The laundry liquid composition of claim 1, wherein the one or more anionic substituents of Y^{A1} is selected from the group consisting of carboxylate, phosphonate, phosphate, sulphonate, and combinations thereof.

10. The laundry liquid composition of claim 1, wherein
Y^{A2} is a 1,3-phenylene moiety having 1 to 4 anionic substituents.

11. The laundry liquid composition of claim 1, wherein the one or more anionic substituents of Y^{A2} is selected from the group consisting of carboxylate, phosphonate, phosphate, sulphonate, and combinations thereof.

12. The laundry liquid composition of claim 1, wherein
Y^{N1} is an unsubstituted 1,4-phenylene moiety.

13. The laundry liquid composition of claim 1, wherein
Y^{N2} is an unsubstituted 1,3-phenylene moiety.

14. The laundry liquid composition of claim 1, wherein A is ethylene substituted with C₁₋₄ alkyl substituents.

15. The laundry liquid composition of claim 5, wherein the preservatives include bactericides.
